(19) United States
(12) Patent Application Publication
(10) Pub. No.: US 2011/0095965 A1
(43) Pub. Date: Apr. 28, 2011

(54) MULIT-SCREEN DISPLAY DEVICE

(76) Inventors: Isao YONEOKA, Tokyo (JP); Yoshinori Asamura, Tokyo (JP)

(21) Appl. No.: 12/885,003

(22) Filed: Sep. 17, 2010

(30) Foreign Application Priority Data
Oct. 27, 2009 (JP) JP2009-246053

(51) Int. Cl. G09G 5/00

(52) U.S. Cl. 345/1.1

(57) ABSTRACT

A multi-screen display device of the present invention includes a master liquid crystal display device and one or more slave liquid crystal display devices which are mutually communicable with each other. Each of the liquid crystal display devices includes an LCD panel, a brightness sensor, brightness adjustment value adjustment means, and backlight control means. The brightness sensor is provided on a rear face side of the LCD panel, and detects the brightness of a backlight. The brightness adjustment value adjustment means adjusts a brightness adjustment value based on a result of comparison between a brightness measured by the brightness sensor and target brightness. The backlight control means adjusts the brightness of the LCD panel by controlling a time period for lighting the backlight based on the brightness adjustment value. The master liquid crystal display device further has target brightness adjustment means for receiving the brightness adjustment values from the slave liquid crystal display devices and adjusting the target brightness based on the brightness adjustment values of all of said liquid crystal display devices including the master liquid crystal display device itself.

### BACKGROUND OF THE INVENTION

1. Field of the Invention

The present invention relates to a multi-screen display device which provides a screen enlargement by a combination of a plurality of liquid crystal display devices and which is capable of controlling the brightness of each of the liquid crystal display devices so as to keep the brightness of the entire multi-screen uniform.

2. Description of the Background Art

Conventionally, in a multi-screen display device which provides a screen enlargement by a combination of a plurality of liquid crystal display devices, the brightness of the display surface of each liquid crystal display device is ensured by a light given from a backlight which is provided on a rear face side of the liquid crystal display device.

The brightness of the backlight is controlled by PWM (Pulse Width Modulation). Lighting of the backlight is controlled in accordance with a pulse width of a pulse generated by a backlight pulse control section. That is, the backlight pulse control section converts a brightness control parameter inputted from the outside into a backlight pulse width, and lighting of the backlight is controlled in accordance with the pulse width obtained as a result of the conversion, to thereby control the brightness of the backlight.

Brightness characteristics of such a liquid crystal display device are not only determined by transmittance characteristics of an LCD panel but also influenced by brightness characteristics of the backlight. However, since the transmittance characteristics of the LCD panel depend on a liquid crystal material and the like, the transmittance characteristics of the LCD panel cannot be freely set or changed. Additionally, the brightness of the backlight largely changes due to degradation over time and temperature characteristics.

Accordingly, even when backlights are lighted by the PWM control for the same time period, the brightness may differ among individual liquid crystal display devices due to individual variations, environment of use, and the like. Therefore, a multi-screen display device has been proposed in which a brightness sensor constantly monitors brightness characteristics of each of liquid crystal display devices included in a multi-screen so as to make brightness values of the respective liquid crystal display devices uniform (see Japanese Patent Application Laid-Open No. 2007-183397).

However, in the conventional multi-screen display device, there is a problem that the brightness sensor is provided at a front surface side of each liquid crystal display device included in the multi-screen and therefore display contents are partially hidden by the brightness sensor. Additionally, there is still a need for an effort to keep the brightness of the entire multi-screen uniform.

### SUMMARY OF THE INVENTION

The present invention has been made in view of the aforementioned problems, and it is an object of the present invention to provide a multi-screen display device which keeps the brightness of an entire multi-screen uniform and prevents display contents from being hidden by a brightness sensor.

A multi-screen display device according to the present invention is a multi-screen display device including a master liquid crystal display device and one or more slave liquid crystal display devices which are mutually communicable with each other. Each of the liquid crystal display devices includes an LCD panel, a brightness sensor, brightness adjustment value adjustment means, and backlight control means. The brightness sensor is provided on a rear face side of the LCD panel and detects the brightness of a backlight. The brightness adjustment value adjustment means adjusts a brightness adjustment value which is a parameter for controlling the brightness of the backlight, based on a result of comparison between a brightness measured by the brightness sensor and a target brightness. The backlight control means adjusts the brightness of the LCD panel by controlling a time period for lighting the backlight based on the brightness adjustment value.

The master liquid crystal display device further includes target brightness adjustment means. The target brightness adjustment means receives the brightness adjustment values from the slave liquid crystal display devices and adjusts the target brightness based on the brightness adjustment values of all of the liquid crystal display devices including the master liquid crystal display device itself.

Since the brightness sensor is provided on the rear face side of the LCD panel, hiding of display contents by the brightness sensor can be prevented. Since the master liquid crystal display device has the target brightness adjustment means, the brightnesses of all the liquid crystal display devices can be made uniform.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a configuration of a multi-screen display device of a preferred embodiment 1;

FIG. 2 is a block diagram showing a configuration of a liquid crystal display device of the preferred embodiment 1;

FIG. 3 is a flowchart showing an operation of a slave liquid crystal display device of the preferred embodiment 1;

FIG. 4 is a flowchart showing an operation of a master liquid crystal display device of the preferred embodiment 1;

FIG. 5 shows a relationship between a backlight brightness value and an LCD panel brightness value;

FIG. 6 is a flowchart showing an operation of a slave liquid crystal display device of a preferred embodiment 2; and

FIG. 7 is a flowchart showing an operation of a master liquid crystal display device of the preferred embodiment 2.

### DESCRIPTION OF THE PREFERRED EMBODIMENTS

### Preferred Embodiment 1

<Configuration>

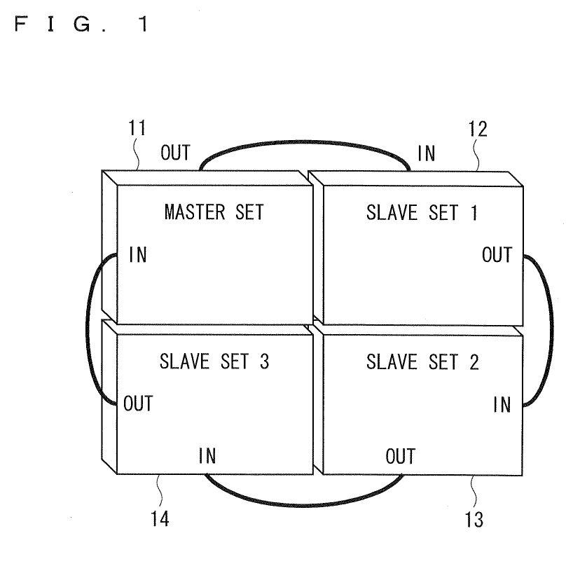

FIG. 1 is a diagram showing a configuration of a multi-screen display device of this preferred embodiment. The multi-screen display device includes a master liquid crystal display device 11 (master set), a slave liquid crystal display device 12 (slave set 1), a slave liquid crystal display device 13 (slave set 2), and a slave liquid crystal display device 14 (slave set 3). Although in this preferred embodiment, a description will be given of a multi-screen display device including one master liquid crystal display device and three slave liquid crystal display devices, any number of slave liquid crystal display devices may be used as long as the number is equal to or more than one.

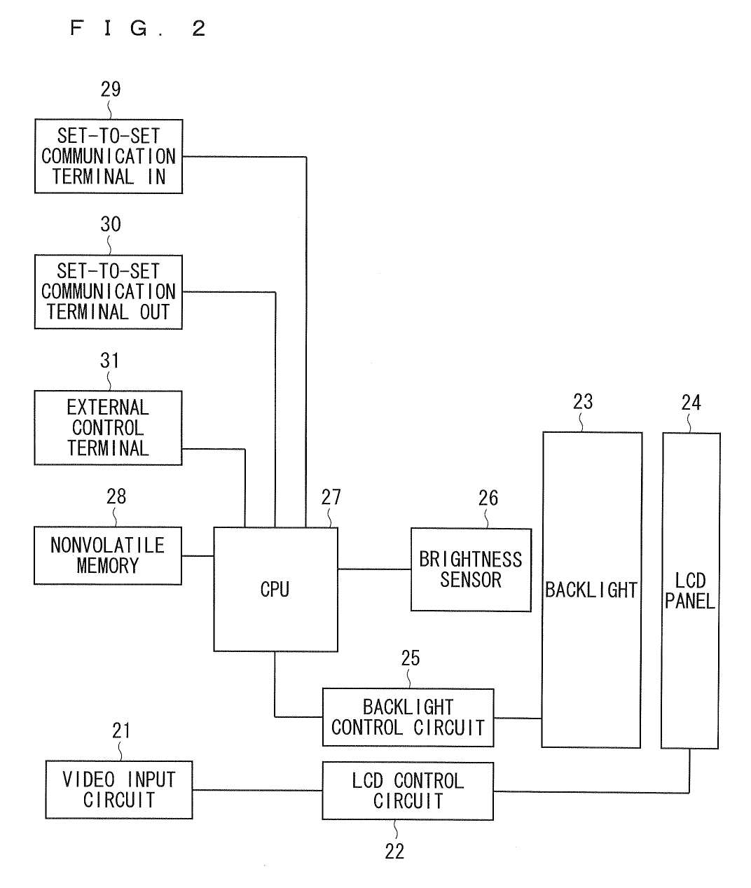

FIG. 2 shows an internal configuration of each of the liquid crystal display devices 11 to 14. Each of the liquid crystal display devices 11 to 14 has a set-to-set communication terminal IN 29, a set-to-set communication terminal OUT 30, and an external control terminal 31. Through these communication terminals, the liquid crystal display devices are connected to one another via a bi-directional communication cable. The master liquid crystal display device 11 performs set-to-set communication with the slave liquid crystal display devices 12 to 14. Also, a control can be made by an external PC or the like through the external control terminal 31.

Each of the liquid crystal display devices 11 to 14 also has an LCD panel 24, a backlight 23 serving as a light source of the LCD panel 24, a brightness sensor 26 provided on a rear face side of the LCD panel to measure the brightness of the backlight 23, a video input circuit 21 that outputs a video signal, and an LCD control circuit 22 that receives the video signal from the video input circuit 21 and controls the LCD panel 24 to polarize a light outputted from the backlight 23 and display a video image.

Each of the liquid crystal display devices 11 to 14 further has a CPU 27 that calculates parameters, a nonvolatile memory 28 that stores some of the parameters, and a backlight control circuit 25 that controls the brightness of the backlight 23 by a PWM control. The backlight control circuit 25 converts a backlight brightness adjustment value D calculated by the CPU 27 into a backlight pulse width, and controls lighting of the backlight 23 in accordance with the pulse width obtained as a result of the conversion, to thereby control the brightness of the backlight 23. As the backlight brightness adjustment value D is greater, the backlight pulse width outputted by the backlight control circuit 25 becomes wider, so that a time period for lighting the backlight 23 becomes longer to increase the brightness.

<Operation>

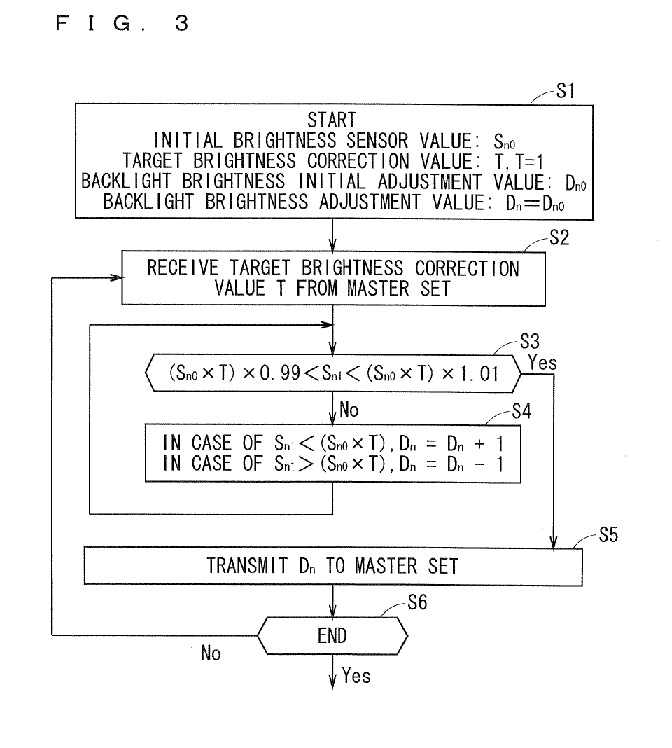

FIG. 3 is a flowchart showing an operation of the slave liquid crystal display devices 12 to 14 included in the multi-screen display device of this preferred embodiment. In the following, an operation of the slave liquid crystal display devices 12 to 14 will be described along the procedure in FIG. 3.

Firstly, when a user performs initial setting to adjust the brightness of each of the liquid crystal display devices 11 to 14 of the multi-screen display device such that an entire multi-screen has uniform brightness, each of the slave liquid crystal display devices 12 to 14 stores, in the nonvolatile memory 28, an initial sensor value Sₙ₀ which is an output value of the brightness sensor 26 and a backlight brightness initial adjustment value Dₙ₀, as initial values. Additionally, each of the slave liquid crystal display devices 12 to 14 initializes the backlight brightness adjustment value Dₙ into Dₙ=Dₙ₀, and a target brightness correction value T into T=1 (step S1). Here, the subscript n means the number representing each slave liquid crystal display device, namely, n=1 represents the slave liquid crystal display device 12, n=2 represents the slave liquid crystal display device 13, and n=3 represents the slave liquid crystal display device 14.

Then, the CPU 27 receives the target brightness correction value T from the master liquid crystal display device 11 (step S2).

The CPU 27 periodically monitors a current output value Sₙ₁ of the brightness sensor 26, and determines whether a difference between the current brightness value Sₙ₁ and the value Sₙ₀×T is converged within a certain range or not. In FIG. 3, a condition for the determination is that the difference between Sₙ₁ and Sₙ₀×T is converged within a range of ±1% (step S3).

When it is determined in step S3 that the difference between the current brightness value Sₙ₁ and the value Sₙ₀×T is not converged within the certain range, the CPU 27 corrects the backlight brightness adjustment value Dn as follows, and then the process returns to step 3. That is, in a case of Sₙ₁<(Sₙ₀×T), the CPU 27 makes a correction for increasing Dₙ by one, and in a case of Sₙ₁>(Sₙ₀×T), the CPU 27 makes a correction for reducing Dₙ by one (step S4).

When it is determined in step S3 that the difference between the current brightness value Sₙ₁ and the value Sₙ₀×T is converged within the certain range, the CPU 27 transmits the current backlight brightness adjustment value Dₙ to the master liquid crystal display device 11 (step S5). In this manner, in the slave liquid crystal display devices 12 to 14, the CPU 27 operates as brightness adjustment value adjustment means for adjusting the backlight brightness adjustment value Dₙ, based on a result of comparison between the brightness measured by the brightness sensor 26 and the target brightness Sₙ₀×T.

Then, when there is a command to end in step S6, the process ends. When there is no command to end in step S6, the process returns to step S2, and the brightness of the liquid crystal display device is corrected by using the target brightness correction value T received from the master liquid crystal display device 11.

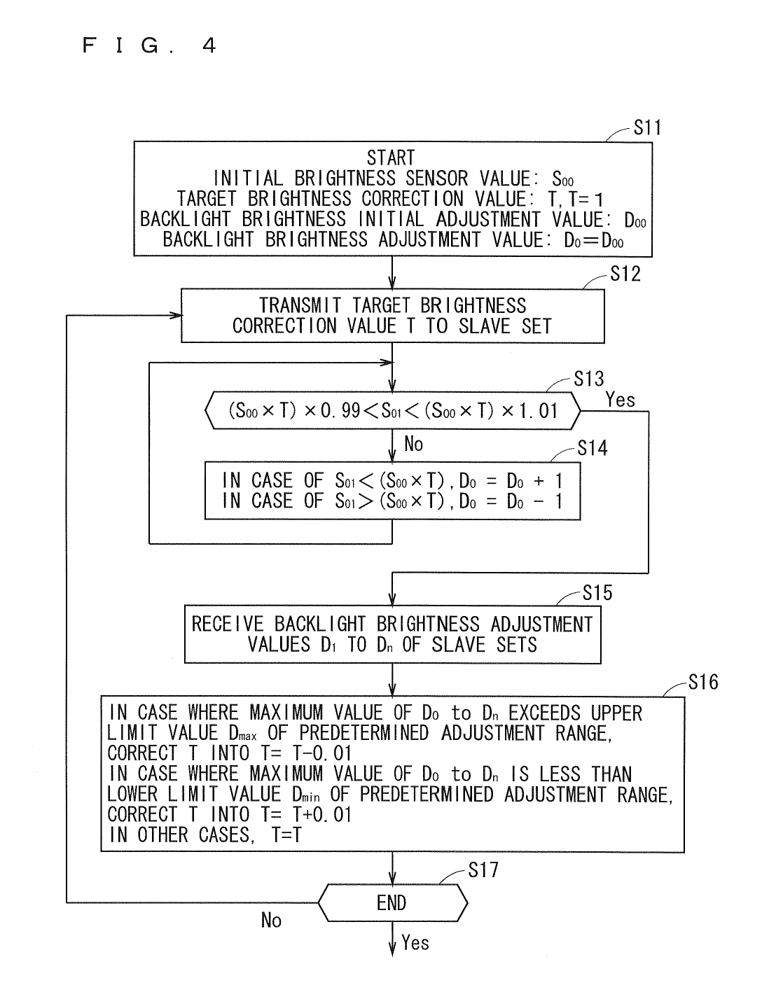

On the other hand, in the master liquid crystal display device 11, a control shown in FIG. 4 is performed. FIG. 4 is a flowchart showing an operation of the master liquid crystal display device 11 included in the multi-screen display device of this preferred embodiment.

Firstly, when a user performs initial setting to adjust the brightness of each of the liquid crystal display devices 11 to 14 of the multi-screen display device such that the entire multi-screen has uniform brightness, the master liquid crystal display device 11 stores, in the nonvolatile memory 28, an initial sensor value S₀₀ which is an output value of the brightness sensor 26 and a backlight brightness initial adjustment value D₀₀, as initial values. Additionally, the master liquid crystal display device 11 initializes the backlight brightness adjustment value D₀ into D₀=D₀₀, and a target brightness correction value T into T=1 (step S11).

Then, the CPU 27 transmits the value T to the slave liquid crystal display devices 12 to 14 (step S12). At a stage after the initial setting, the CPU 27 transmits the value T=1 to the slave liquid crystal display devices 12 to 14.

The CPU 27 periodically monitors a current output value S₀₁ of the brightness sensor 26, and determines whether a difference between the current brightness value S₀₁ and the value S₀₀×T is converged within a certain range or not. In FIG. 4, a condition for the determination is that the difference between S₀₁ and S₀₀×T is converged within a range of ±1% (step S13).

When it is determined in step S13 that the difference between the current brightness value S₀₁ and the value S₀₀×T is not converged within the certain range, the CPU 27 corrects the backlight brightness adjustment value D₀ as follows, and then the process returns to step 13. That is, in a case of S₀₁<(S₀₀×T), the CPU 27 increases D₀ by one, and in a case of S₀₁>(S₀₀×T), the CPU 27 reduces D₀ by one (step S14). In this manner, in the master liquid crystal display device 11, the CPU 27 operates as brightness adjustment value adjustment means for adjusting the backlight brightness adjustment value D₀, based on a result of comparison between the brightness measured by the brightness sensor 26 and the target brightness S₀₀×T.

When it is determined in step S13 that the difference between the current brightness value S₀₁ and the value S₀₀×T is converged within the certain range, the CPU 27 receives the current backlight brightness adjustment values D₁ to Dₙ respectively from the slave liquid crystal display devices 12 to 14 (step S15).

When the CPU 27 receives all of the backlight brightness adjustment values Dₙ from the slave liquid crystal display devices 12 to 14 in step S15, the CPU 27 detects the maximum value of D₀ to Dₙ, compares the maximum value of D₀ to Dₙ with predetermined threshold values Dₘₐₓ and Dₘᵢₙ, and corrects the target brightness correction value T as follows (step S16). That is, in a case of the maximum value of D₀ to Dₙ>Dₘₐₓ, the CPU 27 sets the value T−0.01 as a new T. In a case of the maximum value D₀ to Dₙ<Dₘᵢₙ, the CPU 27 sets the value T+0.01 as a new T. In other cases, the CPU 27 does not change T. In this manner, in the master liquid crystal display device 11, the CPU 27 operates as target brightness adjustment means for adjusting the target brightness based on the backlight brightness adjustment values Dₙ of all the liquid crystal display devices 11 to 14.

Then, when there is a command to end in step S17, the process ends. When there is no command to end in step S17, the process returns to step S12, and the target brightness correction value T corrected in S16 is transmitted to the slave liquid crystal display devices 12 to 14.

In this manner, a multi-screen display device of the preferred embodiment 1 is a multi-screen display device includes the master liquid crystal display device 11 and one or more slave liquid crystal display devices 12 to 14 which are mutually communicable with each other. Each of the liquid crystal display devices 11 to 14 has the LCD panel 24, the brightness sensor 26, the brightness adjustment value adjustment means (CPU 27), and the backlight control circuit 25 (backlight control means). The brightness sensor 26 is provided on the rear face side of the LCD panel 24, and detects the brightness of the backlight 23. The brightness adjustment value adjustment means (CPU 27) adjusts the backlight brightness adjustment value Dₙ which is a parameter for controlling the brightness of the backlight 23 based on the result of comparison between the brightness measured by the brightness sensor 26 and the target brightness. The backlight control circuit 25 (backlight control means) adjusts the brightness of the LCD panel 24 by controlling the time period for lighting the backlight 23 based on the backlight brightness adjustment value D. The master liquid crystal display device 11 further has the target brightness adjustment means (CPU 27) for receiving the backlight brightness adjustment values from the slave liquid crystal display devices 12 to 14 and adjusting the target brightness based on the backlight brightness adjustment values of all the liquid crystal display devices 11 to 14 including the master liquid crystal display device 11 itself. Since the brightness sensor 26 is provided on the rear face side of the LCD panel 24, hiding of display contents by the brightness sensor 26 can be prevented, and the brightness of the liquid crystal display device can be unified into the appropriate target brightness.

The target brightness is a product of the brightness Sₙ₀ measured by the brightness sensor 26 at the time of initial setting and the target brightness correction value T. The brightness adjustment value adjustment means adjusts the backlight brightness adjustment value Dₙ until the difference between the target brightness Sₙ₀×T and the current brightness measured by the brightness sensor 26 is converged within a certain range. The target brightness adjustment means receives the backlight brightness adjustment values obtained as a result of the adjustment from the slave liquid crystal display devices 12 to 14, and makes a correction for reducing the target brightness correction value T when the maximum value of all the backlight brightness adjustment values including the backlight brightness adjustment value of the master liquid crystal display device 11 itself exceeds a predetermined upper limit value Dₘₐₓ, and makes a correction for increasing the target brightness correction value T when the maximum value of the backlight brightness adjustment values is less than a predetermined lower limit value D. This can prevent shortening of the lifespan of the backlight 23 due to an excessive load, a failure due to a temperature rise within the liquid crystal display device, and the like.

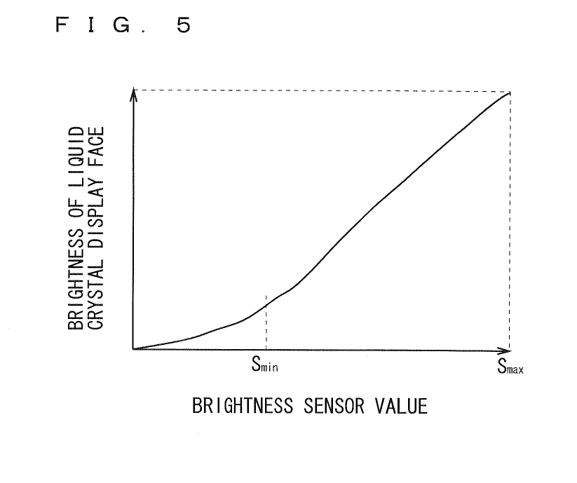

A relationship between the brightness value of the backlight 23 detected by the brightness sensor 26 and an actual brightness value on the LCD panel 24 is as shown in FIG. 5. When the brightness value of the backlight 23 is controlled within a range of Sₘᵢₙ to Sₘₐₓ, the relationship between the brightness value of the backlight 23 and the actual brightness on the LCD panel 24 is expressed as linear-shaped characteristics. In a case of FIG. 5, when the brightness value of the backlight 23 is controlled within a range of approximately 100% to 30%, the actual brightness of the LCD panel 24 also proportionately changes within the range of 100% to 30%.

Accordingly, when the target brightness value of the backlight 23 is reduced by using the target brightness correction value T, the actual brightness value on the LCD panel 24 is also reduced in proportion to the brightness value of the backlight 23. Therefore, by adjusting the brightness value of the backlight 23, the brightness of the entire multi-screen can be kept uniform. For example, when the target brightness correction value T is set at T=0.9, the brightness values of the backlights 23 of all the liquid crystal display devices are set at 90% of the initially set value, and proportionally the brightness on the LCD panel 24 is similarly reduced to 90%. Accordingly, by measuring the brightness of the backlight 23 by using the brightness sensor 26 provided on the rear face side of the LCD panel 24 and then adjusting the brightness, the brightness value on the LCD panel 24 can be set at a desired value.

The liquid crystal display device included in the multi-screen display device of this preferred embodiment has the LCD panel 24, and the brightness sensor 26 that is provided on the rear face side of the LCD panel 24 and detects the brightness of the backlight 23. Since the brightness sensor 26 is not provided on a front face of the LCD panel 24, display contents are not hidden by the brightness sensor 26.

When the backlight brightness adjustment value D is increased, the brightness value of the backlight 23 increases. However, if the backlight brightness adjustment value D is excessively increased, that is, the pulse width is excessively increased, current equal to or larger than an allowable value flows through the backlight 23, which may shorten the lifespan of the backlight 23 or cause heat generation to raise the temperature inside the liquid crystal display device so that the product operating environment temperature cannot be kept. Therefore, the upper limit value Dₘₐₓ is set for the backlight brightness adjustment value D, and when a value equal to or greater than Dₘₐₓ is set, the target brightness correction value T of the entire multi-screen display device is reduced.

On the other hand, the lower limit value Dₘᵢₙ of the backlight brightness adjustment value D is set so as to avoid excessive reduction in the target brightness of the entire multi-screen display device which is caused by excessive reduction in the target brightness correction value T. For example, the brightness of each of the liquid crystal display devices 11 to 14 is adjusted at a brightness of 500 cd, and when Dₙ₀ of the liquid crystal display device at the time of initial setting is 100, Dₘₐₓ and Dₘᵢₙ are set at ±20% of Dₙ₀ (Dₘₐₓ=120, Dₘᵢₙ=80), respectively.

In this preferred embodiment, the user performs the initial setting adjustment such that the entire multi-screen has the uniform brightness, and an output value outputted from the brightness sensor 26 at this time serves as an initial brightness sensor value. However, it may be also acceptable that an initial sensor value Sₙ₀ and a backlight brightness initial adjustment value Dₙ₀ for setting the brightness of the LCD panel 24 of each liquid crystal display device at a constant value (for example, 500 cd/m²) are stored in advance at a time of shipping from a factory. In this case, the brightness value of the entire multi-screen is the brightness value set at the time of shipping from the factory, and it is not necessary for the user to perform the initial setting adjustment such that the entire multi-screen has the uniform brightness at a time of installation of the multi-screen.

If, when each liquid crystal display device is powered OFF, the target brightness correction value T and the backlight brightness adjustment value Dₙ obtained immediately before the power OFF are stored in the nonvolatile memory 28, after the liquid crystal display device is powered ON again, the brightness of the multi-screen display device can be continuously kept uniform without performing the initial setting in the multi-screen again.

Furthermore, in this preferred embodiment, after the initial setting is completed in step S2 of FIG. 3 and step S12 of FIG. 4, the master liquid crystal display device 11 transmits the target brightness correction value T to the slave liquid crystal display devices 12 to 14. However, since the value T is initialized to 1 in steps S1 and S11, the slave liquid crystal display devices 12 to 14 may receive the target brightness correction value T after transmitting Dₙ to the master liquid crystal display device 11 in step S5. Additionally, the master liquid crystal display device 11 may make a control so as to transmit T to the slave liquid crystal display devices 12 to 14 after correcting T in step S16.

Moreover, although the brightness sensor 26 is provided on the rear face side of the LCD panel 24, it is also conceivable that the brightness sensor 26 is not provided on the rear face side of the LCD panel 24. That is, in the multi-screen display device of the present invention, each of the liquid crystal display devices 11 to 14 has the LCD panel 24, the brightness sensor 26, the brightness adjustment value adjustment means (CPU 27), and the backlight control circuit 25 (backlight control means). The brightness sensor 26 is provided on the LCD panel 24, and detects the brightness of the backlight 23. The brightness adjustment value adjustment means (CPU 27) adjusts the backlight brightness adjustment value Dₙ which is a parameter for controlling the brightness of the backlight 23, based on the result of comparison between the brightness measured by the brightness sensor 26 and the target brightness. The backlight control circuit 25 (backlight control means) adjusts the brightness of the LCD panel 24 by controlling the time period for lighting the backlight 23 based on the backlight brightness adjustment value Dₙ. The master liquid crystal display device 11 further has the target brightness adjustment means (CPU 27) for receiving the backlight brightness adjustment values Dₙ from the slave liquid crystal display devices 12 to 14 and adjusting the target brightness based on the backlight brightness adjustment values of all the liquid crystal display devices 11 to 14 including the master liquid crystal display device 11 itself. In this case, the effect that the brightness of the multi-screen is kept uniform can be obtained, which is one of the problems to be solved by the present invention.

<Effect>

In the multi-screen display device of this preferred embodiment, as already described, the following effects can be obtained. That is, the multi-screen display device of the preferred embodiment 1 is the multi-screen display device including the master liquid crystal display device 11 and one or more slave liquid crystal display devices 12 to 14 which are mutually communicable with each other. Each of the liquid crystal display devices 11 to 14 has the LCD panel 24, the brightness sensor 26, the brightness adjustment value adjustment means (CPU 27), and the backlight control circuit 25 (backlight control means). The brightness sensor 26 is provided on the rear face side of the LCD panel 24, and detects the brightness of the backlight 23. The brightness adjustment value adjustment means (CPU 27) adjusts the backlight brightness adjustment value Dₙ which is a parameter for controlling the brightness of the backlight 23, based on the result of comparison between the brightness measured by the brightness sensor 26 and the target brightness. The backlight control circuit 25 (backlight control means) adjusts the brightness of the LCD panel 24 by controlling the time period for lighting the backlight 23 based on the backlight brightness adjustment value D. The master liquid crystal display device 11 further has the target brightness adjustment means (CPU 27) for receiving the backlight brightness adjustment values from the slave liquid crystal display devices 12 to 14 and adjusting the target brightness based on the backlight brightness adjustment values of all the liquid crystal display devices 11 to 14 including the master liquid crystal display device 11 itself. Since the brightness sensor 26 is provided on the rear face side of the LCD panel 24, hiding of display contents by the brightness sensor 26 can be prevented, and the brightness of the liquid crystal display device can be unified into the appropriate target brightness.

The target brightness is a product of the brightness Sₙ₀ measured by the brightness sensor 26 at the time of initial setting and the target brightness correction value T. The brightness adjustment value adjustment means adjusts the backlight brightness adjustment value Dₙ until the difference between the target brightness Sₙ₀×T and the current brightness measured by the brightness sensor 26 is converged within a certain range. The target brightness adjustment means receives the backlight brightness adjustment values obtained as a result of the adjustment from the slave liquid crystal display devices 12 to 14, and makes a correction for reducing the target brightness correction value T when the maximum value of all the backlight brightness adjustment values including the backlight brightness adjustment value of the master liquid crystal display device 11 itself exceeds a predetermined upper limit value Dₘₐₓ, and makes a correction for increasing the target brightness correction value T when the maximum value of the backlight brightness adjustment values is less than a predetermined lower limit value Dₘᵢₙ. By detecting the brightness value of the backlight 23 at the time of initial adjustment by using the brightness sensor 26 to record the value as the initial value and then adjusting the backlight brightness adjustment value Dₙ for controlling the time period for lighting the backlight 23, the brightnesses of all the liquid crystal display devices can be constantly kept uniform. Moreover, when the brightness of the backlight 23 is reduced because of aging, a control is performed such that when the backlight brightness adjustment value Dₙ exceeds the upper limit value Dₘₐₓ, the target brightness of the entire multi-screen display device is reduced. Accordingly, the backlight brightness adjustment value Dₙ can be controlled to a value equal to or less than a certain value while the brightnesses of all the liquid crystal display devices are kept uniform. Thus, a problem does not occur that excessive current flows through the backlight 23 to shorten the lifespan of the backlight 23, or the temperature inside the liquid crystal display device rises due to heat generation of the backlight 23.

Alternatively, the liquid crystal display device included in the multi-screen display device of this preferred embodiment has the LCD panel 24, and the brightness sensor 26 that is provided on the rear face side of the LCD panel 24 and detects the brightness of the backlight 23. Since the brightness of the entire multi-screen is controlled by measuring the brightness value of the backlight 23, the brightness sensor 26 can be provided on the rear face side of the LCD panel, and a part of display contents displayed on the multi-screen display device is not hidden by the brightness sensor 26.

Alternatively, in another multi-screen display device of this preferred embodiment, each of the liquid crystal display devices 11 to 14 has the LCD panel 24, the brightness sensor 26, the brightness adjustment value adjustment means (CPU 27), and the backlight control circuit 25 (backlight control means). The brightness sensor 26 is provided on the LCD panel 24, and detects the brightness of the backlight 23. The brightness adjustment value adjustment means (CPU 27) adjusts the backlight brightness adjustment value Dₙ which is a parameter for controlling the brightness of the backlight 23, based on the result of comparison between the brightness measured by the brightness sensor 26 and the target brightness. The backlight control circuit 25 (backlight control means) adjusts the brightness of the LCD panel 24 by controlling the time period for lighting the backlight 23 based on the backlight brightness adjustment value Dₙ. The master liquid crystal display device 11 further has the target brightness adjustment means (CPU 27) for receiving the backlight brightness adjustment values Dₙ from the slave liquid crystal display devices 12 to 14 and adjusting the target brightness based on the backlight brightness adjustment values of all the liquid crystal display devices 11 to 14 including the master liquid crystal display device 11 itself. In this case, the effect that the brightness of the multi-screen is kept uniform can be obtained.

### Preferred Embodiment 2

<Configuration>

A configuration of a multi-screen display device of a preferred embodiment 2 is the same as the configuration of the multi-screen display device of the preferred embodiment 1, and therefore a description thereof is omitted.

<Operation>

In the preferred embodiment 1, in step S3 of FIG. 3 and step S13 of FIG. 4, the backlight brightness adjustment value Dₙ is corrected in each liquid crystal display device until the current brightness value Sₙ₁ satisfies the condition of Sₙ₁=Sₙ₀×T, and the master liquid crystal display device 11 determines the target brightness correction value T by using this Dₙ. However, it is not always necessary that the master liquid crystal display device 11 determines the target brightness correction value T after the brightness value in each liquid crystal display device is converged to or near the target brightness. In the preferred embodiment 2, the target brightness correction value T is corrected simultaneously with performing the brightness adjustment of the backlight 23.

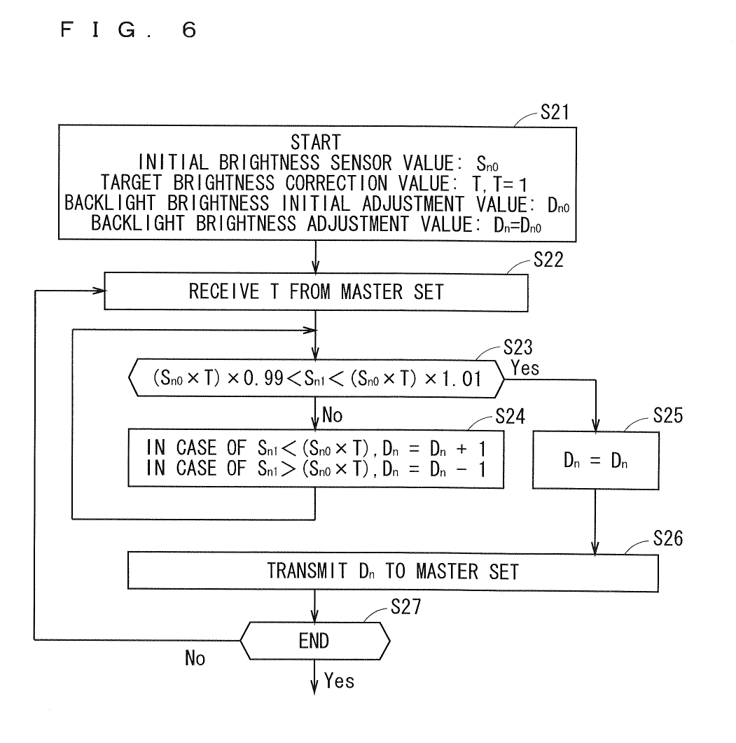

FIG. 6 is a flowchart showing an operation of the slave liquid crystal display devices 12 to 14 included in the multi-screen display device of this preferred embodiment.

Firstly, when a user performs initial setting to adjust the brightness of each of the liquid crystal display devices 11 to 14 of the multi-screen display device such that the entire multi-screen has uniform brightness, each of the slave liquid crystal display devices 12 to 14 stores, in the nonvolatile memory 28, an initial sensor value Sₙₒ which is an output value of the brightness sensor 26 and a backlight brightness initial adjustment value Dₙₒ, as initial values. Additionally, each of the slave liquid crystal display devices 12 to 14 initializes the backlight brightness adjustment value Dₙ into Dₙ=Dₙ₀, and a target brightness correction value T into T=1 (step S21). Here, the subscript n means the number representing each slave liquid crystal display device, namely, n=1 represents the slave liquid crystal display device 12, n=2 represents the slave liquid crystal display device 13, and n=3 represents the slave liquid crystal display device 14.

Then, the CPU 27 receives the target brightness correction value T from the master liquid crystal display device 11 (step S22).

The CPU 27 periodically monitors a current output value Sₙ₁ of the brightness sensor 26, and determines whether a difference between the current brightness value Sₙ₁ and the value Sₙ₀×T is converged within a certain range or not. In FIG. 5, a condition for the determination is that the difference between Sₙ₁ and Sₙ₀×T is converged within a range of ±1% (step S23).

When it is determined in step S23 that the difference between the current brightness value Sₙ₁ and the value Sₙ₀×T is not converged within the certain range, the CPU 27 corrects the backlight brightness adjustment value Dₙ as follows (step S24). That is, in a case of Sₙ₁<(Sₙ₀×T), the CPU 27 makes a correction for increasing Dₙ by one, and in a case of Sₙ₁>(Sₙ₀×T), the CPU 27 makes a correction for reducing Dₙ by one.

When it is determined in step S23 that the difference between the current brightness value Sₙ₁ and the value Sₙ₀×T is converged within the certain range, the current backlight brightness adjustment value Dₙ is maintained (step S25). In this manner, in the slave liquid crystal display devices 12 to 14, the CPU 27 operates as brightness adjustment value adjustment means for adjusting the backlight brightness adjustment value Dₙ, based on a result of comparison between the brightness measured by the brightness sensor 26 and the target brightness Sₙ₀×T.

Then, the current backlight brightness adjustment value Dₙ obtained as a result of the correction in step S24 and step S25 is transmitted to the master liquid crystal display device 11 (step S26).

Then, when there is a command to end in step S27, the process ends. When there is no command to end in step S27, the process returns to step S22, and the brightness of the liquid crystal display device is corrected by using the target brightness correction value T received from the master liquid crystal display device 11.

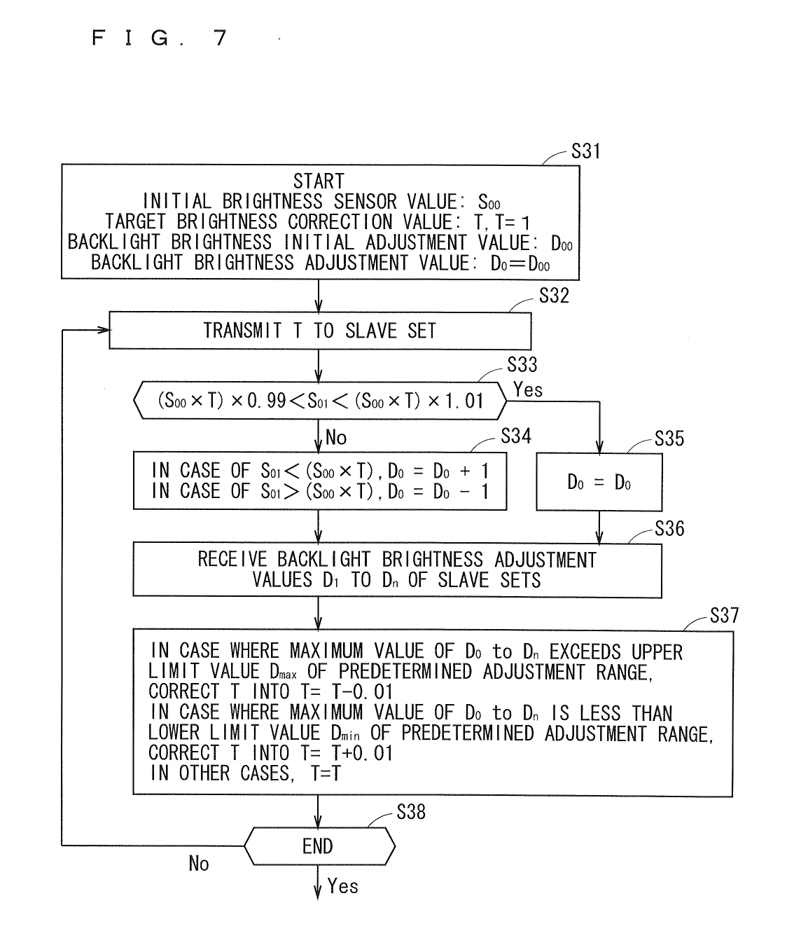

On the other hand, in the master liquid crystal display device 11, a control shown in FIG. 7 is performed. FIG. 7 is a flowchart showing an operation of the master liquid crystal display device 11 included in the multi-screen display device of this preferred embodiment.

Firstly, when a user performs initial setting to adjust the brightness of each of the liquid crystal display devices 11 to 14 of the multi-screen display device such that the entire multi-screen has uniform brightness, the master liquid crystal display device 11 stores, in the nonvolatile memory 28, an initial sensor value S₀ₒ which is an output value of the brightness sensor 26 and a backlight brightness initial adjustment value D₀₀, as initial values. Additionally, the master liquid crystal display device 11 initializes the backlight brightness adjustment value D₀ into D₀=D₀₀, and a target brightness correction value T into T=1 (step S31).

Then, the CPU 27 transmits the value T to the slave liquid crystal display devices 12 to 14 (step S32). At a stage after the initial setting, the value T=1 is transmitted.

Then, a current output value S₀₁ of the brightness sensor 26 is periodically monitored, and whether a difference between the current brightness value S₀₁ and the value S₀₀×T is converged within a certain range or not is determined. In FIG. 7, a condition for the determination is that the difference between S₀₁ and S₀₀×T is converged within a range of ±1% (step S33).

When it is determined in step S33 that the difference between the current brightness value S₀₁ and the value S₀₀×T is not converged within the certain range, the CPU 27 corrects the backlight brightness adjustment value D₀ as follows (step S34). That is, in a case of S₀₁<(S₀₀×T), the CPU 27 increases D₀ by one, and in a case of S₀₁>(S₀₀×T), the CPU 27 reduces D₀ by one.

When it is determined in step S33 that the difference between the current brightness value S₀₁ and the value S₀₀×T is converged within the certain range, the current value of D₀ is maintained (step S35). In this manner, in the master liquid crystal display device 11, the CPU 27 operates as brightness adjustment value adjustment means for adjusting the backlight brightness adjustment value D₀, based on a result of comparison between the brightness measured by the brightness sensor 26 and the target brightness S₀₀×T.

Then, the current backlight brightness adjustment values D₁ to Dₙ are received from the slave liquid crystal display devices 12 to 14 (step S36).

At a time when the CPU 27 receives the backlight brightness adjustment values Dₙ from the slave liquid crystal display devices 12 to 14 in step S36, the CPU 27 detects the maximum value of D₀ to Dₙ, compares the maximum value of D₀ to Dₙ with predetermined threshold values Dₘₐₓ and Dₘᵢₙ, and corrects the target brightness correction value T as follows (step S37). That is, in a case of the maximum value of D₀ to Dₙ>Dₘₐₓ, the CPU 27 sets the value T−0.01 as a new T. In a case of the maximum value D₀ to Dₙ<Dₘᵢₙ, the CPU 27 sets the value T+0.01 as a new T. In other cases, the CPU 27 does not change T. In this manner, in the master liquid crystal display device 11, the CPU 27 operates as target brightness adjustment means for adjusting the target brightness based on the backlight brightness adjustment values Dₙ of all the liquid crystal display devices 11 to 14.

Then, when there is a command to end in step S38, the process ends. When there is no command to end in step S38, the process returns to step S32, and the target brightness correction value T corrected in S37 is transmitted to the slave liquid crystal display devices 12 to 14.

That is, in the multi-screen display device of the preferred embodiment 2, the target brightness is a product of the brightness Sₙ₀ measured by the brightness sensor 26 at the time of initial setting and the target brightness correction value T. When the difference between the target brightness and the current brightness Sₙ₁ measured by the brightness sensor 26 is not converged within the certain range, the brightness adjustment value adjustment means (CPU 27) repeatedly adjusts the backlight brightness adjustment value by a predetermined amount. Each time the backlight brightness adjustment value is adjusted, the target brightness adjustment means (CPU 27) receives the brightness adjustment value Dₙ obtained as a result of the adjustment from each of the slave liquid crystal display devices 12 to 14. When the maximum value of the brightness adjustment values Dₙ including the brightness adjustment value D₀ of the master liquid crystal display device 11 itself exceeds a predetermined upper limit value Dₘₐₓ, a correction is made so as to reduce the target brightness correction value T. When the maximum value of the brightness adjustment values Dₙ is less than a predetermined lower limit value Dₘᵢₙ, a correction is made so as to increase the target brightness correction value T. Irrespective of whether the brightness value Sₙ₁ of the backlight 23 is converged to the target brightness value Sₙ₀×T or not, the maximum value of the current backlight brightness adjustment values D₀ to Dₙ set in all the liquid crystal display devices 11 to 14 is detected and compared with the threshold values Dₘₐₓ and Dₘᵢₙ. Therefore, when the backlight brightness adjustment value Dₙ of a part of the liquid crystal display devices exceeds an allowable value, the target brightness of the entire multi-screen display device can be quickly reduced.

<Effect>

In the multi-screen display device of this preferred embodiment, as already described, the following effects can be obtained. That is, in the multi-screen display device of the preferred embodiment 2, the target brightness is a product of the brightness Sₙ₀ measured by the brightness sensor 26 at the time of initial setting and the target brightness correction value T. When the difference between the target brightness Sₙ₀×T and the current brightness Sₙ₁ measured by the brightness sensor 26 is not converged within a certain range, the brightness adjustment value adjustment means (CPU 27) repeatedly adjusts the backlight brightness adjustment value by a predetermined amount. Each time the backlight brightness adjustment value is adjusted, the target brightness adjustment means (CPU 27) receives the brightness adjustment value Dₙ obtained as a result of the adjustment from each of the slave liquid crystal display devices 12 to 14. When the maximum value of the brightness adjustment values Dₙ including the brightness adjustment value D₀ of the master liquid crystal display device 11 itself exceeds the predetermined upper limit value Dₘₐₓ, the correction is made so as to reduce the target brightness correction value T. When the maximum value of the brightness adjustment values Dₙ is less than the predetermined lower limit value Dₘᵢₙ, the correction is made so as to increase the target brightness correction value T. Irrespective of whether the brightness value Sₙ₁ of the backlight 23 is converged to the target brightness value Sₙ₀×T or not, the maximum value of the current backlight brightness adjustment values D₀ to Dₙ set in all the liquid crystal display devices 11 to 14 is detected and compared with the threshold values Dₘₐₓ and Dₘᵢₙ. Therefore, when the backlight brightness adjustment value Dₙ of a part of the liquid crystal display devices exceeds the allowable value, the target brightness of the entire multi-screen display device can be quickly reduced. Thus, a problem can be suppressed that excessive current flows through the backlight 23 to shorten the lifespan of the backlight 23, or the temperature inside the liquid crystal display device rises due to heat generation of the backlight 23.

While the invention has been shown and described in detail, the foregoing description is in all aspects illustrative and not restrictive. It is therefore understood that numerous modifications and variations can be devised without departing from the scope of the invention.

What is claimed is:

1. A multi-screen display device including a master liquid crystal display device and one or more slave liquid crystal display devices which are mutually communicable with each other, wherein
each of said liquid crystal display devices includes:
an LCD panel;
a brightness sensor that is provided on a rear face side of said LCD panel and detects the brightness of a backlight;
brightness adjustment value adjustment means for adjusting a brightness adjustment value which is a parameter for controlling the brightness of said backlight, based on a result of comparison between a brightness measured by said brightness sensor and a target brightness; and
backlight control means for adjusting the brightness of said LCD panel by controlling a time period for lighting said backlight based on said brightness adjustment value,
said master liquid crystal display device further includes target brightness adjustment means for receiving said brightness adjustment values from said slave liquid crystal display devices and adjusting said target brightness based on said brightness adjustment values of all of said liquid crystal display devices including said master liquid crystal display device itself.

2. The multi-screen display device according to claim 1, wherein
said target brightness is a product of a brightness measured by said brightness sensor at a time of initial setting and a target brightness correction value,
said brightness adjustment value adjustment means adjusts said brightness adjustment value until a difference between said target brightness and a current brightness measured by said brightness sensor is converged within a certain range,
said target brightness adjustment means receives said brightness adjustment values obtained as a result of said adjustment from said slave liquid crystal display devices, and when a maximum value of all of said brightness adjustment values including said brightness adjustment value of said master liquid crystal display device itself exceeds a predetermined upper limit value, said target brightness adjustment means makes a correction for reducing said target brightness correction value, and when the maximum value of said brightness adjustment values is less than a predetermined lower limit value, said target brightness adjustment means makes a correction for increasing said target brightness correction value.

3. The multi-screen display device according to claim 1, wherein
said target brightness is a product of a brightness measured by said brightness sensor at a time of initial setting and a target brightness correction value,
when a difference between said target brightness and a current brightness measured by said brightness sensor is not converged within a certain range, said brightness adjustment value adjustment means repeatedly adjusts said brightness adjustment value by a predetermined amount,
each time said adjustment of said brightness adjustment value is performed, said target brightness adjustment means receives said brightness adjustment values obtained as a result of the adjustment from said slave liquid crystal display devices, and when a maximum value of all of said brightness adjustment values including said brightness adjustment value of said master liquid crystal display device itself exceeds a predetermined upper limit value, said target brightness adjustment means makes a correction for reducing said target brightness correction value, and when the maximum value of said brightness adjustment values is less than a predetermined lower limit value, said target brightness adjustment means makes a correction for increasing said target brightness correction value.

4. A multi-screen display device including a plurality of liquid crystal display devices, wherein
each of said liquid crystal display devices includes:
an LCD panel; and
a brightness sensor that is provided on a rear face side of said LCD panel and detects the brightness of a backlight.

5. A multi-screen display device including a master liquid crystal display device and one or more slave liquid crystal display devices which are mutually communicable with each other, wherein
each of said liquid crystal display devices includes:
an LCD panel;
a brightness sensor that is provided on said LCD panel and detects the brightness of a backlight;
brightness adjustment value adjustment means for adjusting a brightness adjustment value which is a parameter for controlling the brightness of said backlight, based on a result of comparison between a brightness measured by said brightness sensor and a target brightness; and
backlight control means for adjusting the brightness of said LCD panel by controlling a time period for lighting said backlight based on said brightness adjustment value,
said master liquid crystal display device further includes target brightness adjustment means for receiving said brightness adjustment values from said slave liquid crystal display devices and adjusting said target brightness based on said brightness adjustment values of all of said liquid crystal display devices including said master liquid crystal display device itself.
